(19) United States
(12) Patent Application Publication
(10) Pub. No.: US 2014/0000530 A1
(43) Pub. Date: Jan. 2, 2014

(54) PET-TO-PERSON COMMUNICATING DEVICE FOR BEING OPERATED BY PET'S INSTINCTIVE ACT AND METHOD FOR USE WITH THE SAME

(71) Applicants: Ricardo SALAS, Parkville, MO (US); Donald Richard Bradrick, Independence, MO (US)

(72) Inventors: Ricardo SALAS, Parkville, MO (US); Donald Richard Bradrick, Independence, MO (US)

(21) Appl. No.: 13/538,311

(22) Filed: Jun. 29, 2012

(51) Int. Cl. A01K 29/00

(52) U.S. Cl. 119/707

(57) ABSTRACT

A pet-to-person communicating device and a method for use with the same are provided. The pet-to-person communicating device comprises a base, at least an operating element disposed at the base and capable of being operated by aforesaid pet's pawing motion, a circuit module, a speaker electrically connected to the circuit module, and at least a switch electrically connected to the circuit module. The circuit module has a controller and a memory for storing at least a sound signal. The switch is controlled by the operating element to send a start signal to the circuit module when the operating element is operated such that the circuit module sends to the speaker a sound signal corresponding to the start signal to enable the speaker to generate a sound corresponding to the sound signal. The device enabling the pet communicate with person by its instinctive act is structurally simple and easy to use.

### BACKGROUND OF THE INVENTION

1. Technical Field

The present invention relates to apparatus for pets, and more particularly, to a pet-to-person communicating device for being operated by pet's instinctive act and a method for use with the same, wherein the playback of recorded sound is initiated by a pet's pawing motion on the device so that the pet can hears the playback it has initiated as well as the person and interact with the person.

2. Description of Related Art

From the ancient time to the present time, there is a close relationship between the pet and the human. At the initial stage of the human history, people bred the pets for the purpose of assisting them in hunting, hauling vehicle, or taking care of livestock. As developed to enter the industrial society, the modern person's attitudes to the pet has gradually become psychological and emotional anchorage, so the pet being used to function as a tool in the past can enter the house and reach the room, accompany the person to live together, and become a stable mental support for the person. More and more academic researches indicate that the person with the pets' company are not only healthier but improve the interpersonal relationship with others.

In the traditional interaction between the pet and person, the communication between them and their expressive behaviors are different very much, so it is based on the architecture “domination-compliance”; namely, the person commands all of the behaviors of the pet by high power. Many currently commercially available pet training apparatuses are based on punishment and reward to enable the pets to passively understand what the persons think.

In fact, in the process of interaction between the pets and the person, owners may be frequently subject to their own emotions or environments to fail to convey correct messages for the pets to understand. Besides, the pets, as such, have their inherent communicative and expressive manners. However, presently the pets fail to communicate with the person directly by their instinctive act, so the different expressive manners tend to result in misunderstandings between the pets and the person.

### SUMMARY OF THE INVENTION

In view of the aforesaid drawbacks of the prior art, it is an objective of the present invention to provide a pet-to-person communicating device for being operated by pet's instinctive act and a method for use with the same, wherein the playback of recorded sound is initiated by a pet's pawing motion on the device so that the pet can interact with the human.

The present invention is primarily designed for dogs but can be used by other animals with a similar pawing motion. Therefore, the word “pet” in present invention means dogs and other animals having instinctive pawing motion.

In order to achieve the above and other objectives, the present invention provides a pet-to-person communicating device for being operated by pet's instinctive act, comprising: a base, at least an operating element disposed at the base and capable of being operated by aforesaid pet's instinctive act, a circuit module, a speaker electrically connected to the circuit module, and at least a switch electrically connected to the circuit module. The circuit module has a controller and a memory electrically connected to the controller. The memory stores at least a sound signal. The switch is controlled by the operating element to send a start signal to the circuit module as soon as the operating element is operated such that the circuit module sends to the speaker a sound signal corresponding to the start signal and thereby causes the speaker to generate a sound corresponding to the sound signal.

A method for use with a pet-to-person communicating device for being operated by pet's instinctive act comprises the steps of:

(a) providing the pet-to-person communicating device;

(b) storing at least a sound signal in a memory of a circuit module of the pet-to-person communicating device; and

(c) applying an operation of the operating element of the pet-to-person communicating device by a pet's pawing motion to make the speaker generate a sound to a person.

Accordingly, the pet-to-person communicating device and the method for use with the same let the pet operate the operating elements by its instinctive act, such as digging, pawing or scratching, to communicate with the person. The person can take the action timely to response the pet and even can store his or her own voice in the form of a sound signal. Therefore, the pet-to-person communicating device can let the pet and the person communicate with each other. Besides, the present invention is also characterized by a simple structure of the pet-to-person communicating device, the convenience in a pet's and a person's not carrying any part of the device, and the ease of use of the device.

The structure, features, assembly, and use of the pet-to-person communicating device for being operated by pet's instinctive act and the method for use with the same according to the present invention are illustrated with a specific embodiment described in detail hereunder. However, persons skilled in the art should understand that the detailed description and the specific embodiment of the present invention are illustrative of the present invention only, but should not be interpreted as restrictive of the scope of the claims of the present invention.

### BRIEF DESCRIPTION OF THE SEVERAL VIEWS OF THE DRAWINGS

The technical solution and features of the present invention are hereunder illustrated with an embodiment in conjunction with the accompanying drawings, in which:

FIG. 1 and FIG. 2 are perspective views of a pet-to-person communicating device for being operated by pet's instinctive act according to a preferred embodiment of the present invention;

FIG. 3 is a perspective view of the pet-to-person communicating device for being operated by pet's instinctive act in FIG. 2 without a rear panel and a circuit module;

FIG. 4 is a cross-sectional view of the pet-to-person communicating device for being operated by pet's instinctive act according to the preferred embodiment of the present invention;

FIG. 5 is a circuit block diagram of the pet-to-person communicating device for being operated by pet's instinctive act according to the preferred embodiment of the present invention; and

FIGS. 6-8 are schematic drawings showing a pet operates the pet-to-person communicating device.

### DETAILED DESCRIPTION OF THE EMBODIMENT OF THE INVENTION

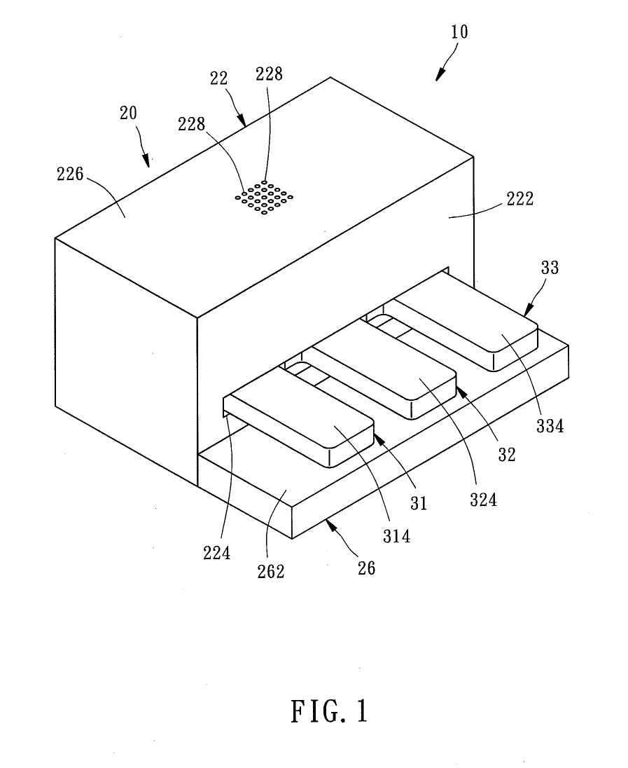

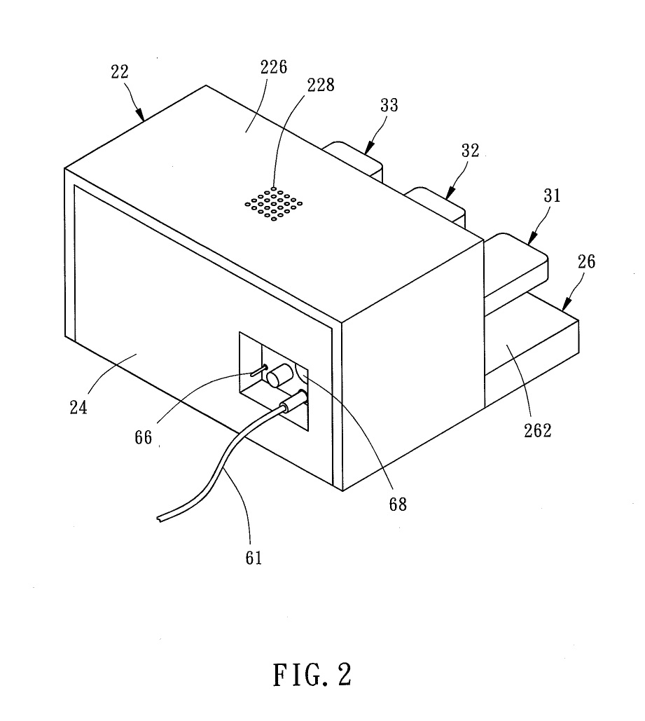

FIG. 1 and FIG. 2 are perspective views of a pet-to-person communicating device for being operated by pet's instinctive act according to a preferred embodiment of the present invention.

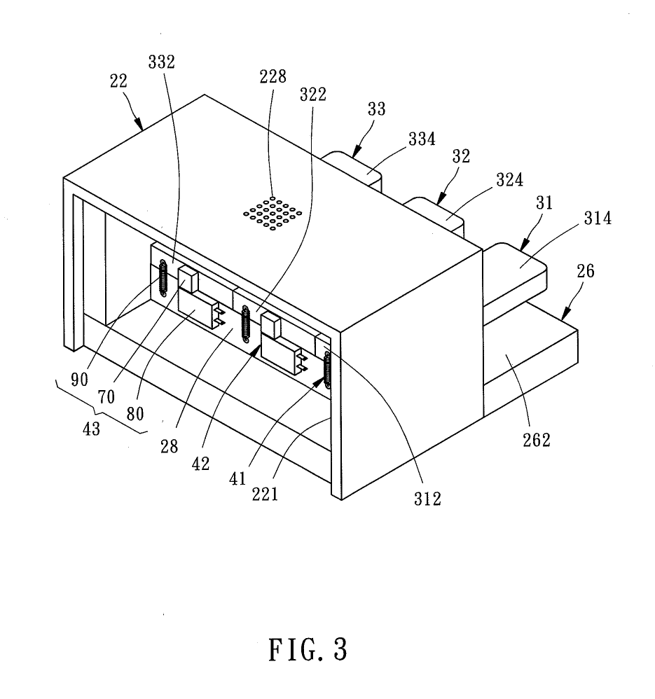

FIG. 3 is a perspective view of the pet-to-person communicating device for being operated by pet's instinctive act in FIG. 2 without a rear panel and a circuit module.

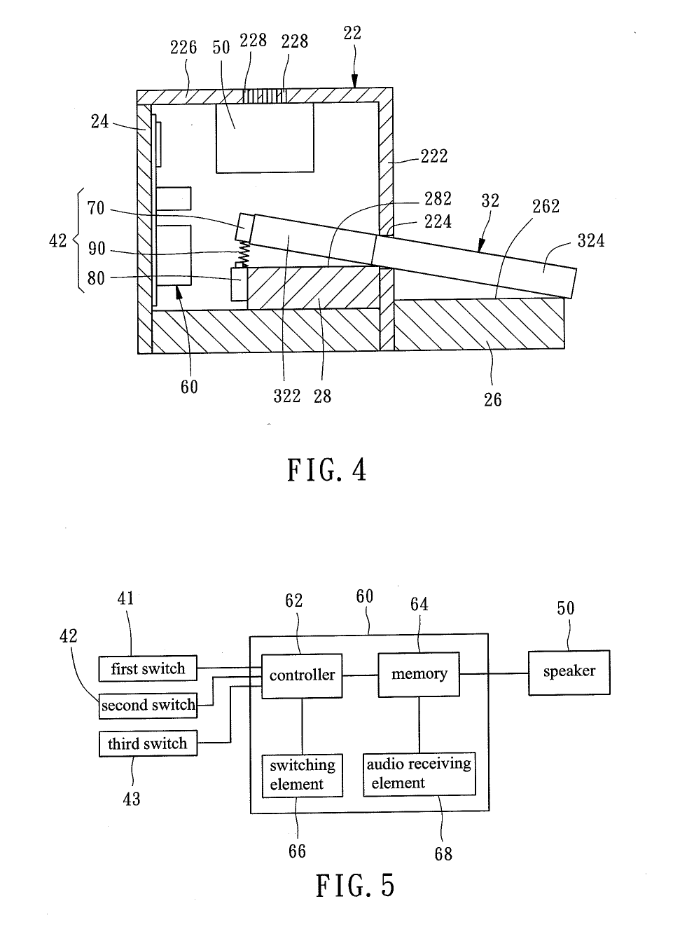

FIG. 4 is a cross-sectional view of the pet-to-person communicating device for being operated by pet's instinctive act according to the preferred embodiment of the present invention.

FIG. 5 is a circuit block diagram of the pet-to-person communicating device for being operated by pet's instinctive act according to the preferred embodiment of the present invention; and

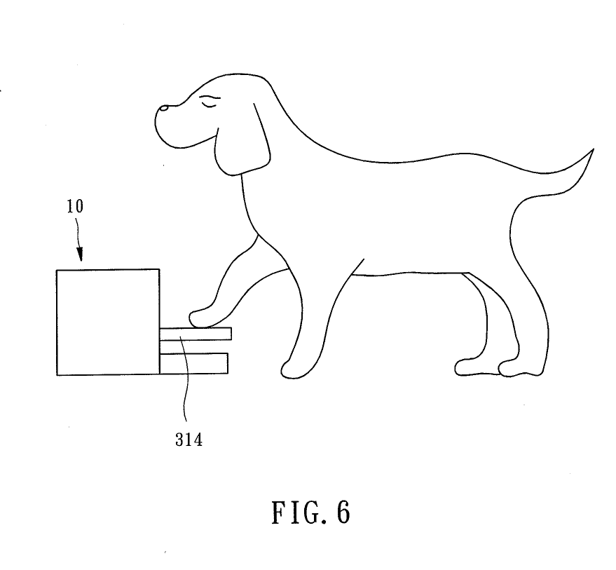

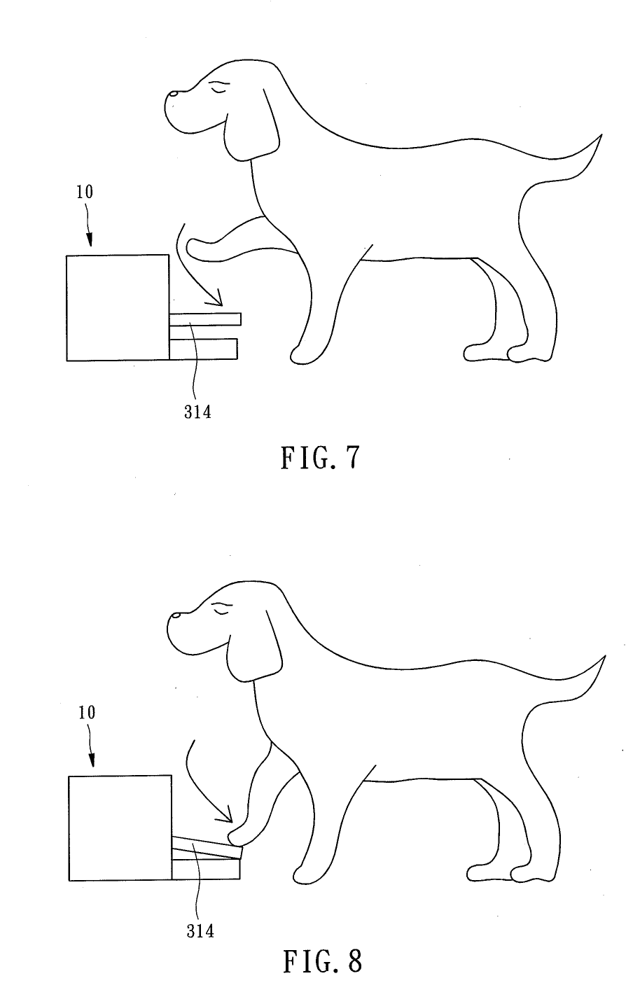

FIGS. 6-8 are schematic drawings showing a pet operates the pet-to-person communicating device.

Referring to the aforesaid drawings, a pet-to-person communicating device for being operated by pet's instinctive act 10 according to the preferred embodiment of the present invention comprises a base 20, a first operating element 31, a second operating element 32, a third operating element 33, a first switch 41, a second switch 42, a third switch 43, a speaker 50, and a circuit module 60.

The base 20 comprises a case 22, a rear panel 24, an external rest 26, and an internal rest 28. The case 22 has a rear opening 221, a front opening 224 penetrating a front panel 222 of the case 22, and a plurality of sound apertures 228 penetrating a top panel 226 of the case 22. The rear panel 24 is disposed at the rear opening 221 of the case 22. The external rest 26 is fixed to the outer side of the front panel 222 and positioned beneath the front opening 224. The internal rest 28 is fixed to the inner side of the front panel 222. A top side 282 of the internal rest 28 is higher than a top side 262 of the external rest 26.

The operating elements 31, 32, 33 penetrate the front opening 224 of the base 20. Rear half portions 312, 322, 332 of the operating elements 31, 32, 33 are disposed above the top side 282 of the internal rest 28. Front half portions 314, 324, 334 of the operating elements 31, 32, 33 are disposed above the external rest 26 in a suspended manner. The operating elements 31, 32, 33 tilt in a manner shown in FIG. 4 as soon as the front half portions 314, 324, 334 are pressed, respectively.

Referring to FIG. 3, the switches 41, 42, 43 are disposed inside the case 22 of the base 20 and each comprise an abutting element 70, a switch body 80, and a resilient element 90. The abutting elements 70 are disposed at the rear ends of the operating elements 31, 32, 33, respectively. The switch bodies 80 are disposed at the rear end of the internal rest 28. The resilient elements 90 each have one end fixed to a corresponding one of the rear ends of the operating elements 31, 32, 33, and each have the other end fixed to the rear end of the internal rest 28. The switch bodies 80 are conventional limit switches. A button (not shown) is disposed at the top of each of the switch bodies 80. When the operating elements 31, 32, 33 have not yet been pressed and tilted, the abutting elements 70 of the switches 41, 42, 43 abut against the buttons at the top of the switch bodies 80. It is feasible that the abutting elements 70 of the switches 41, 42, 43 are integrally formed with the operating elements 31, 32, 33 respectively.

Referring to FIG. 4, when pressed under an external force, the operating element 32 tilts and triggers the separation of the abutting element 70 and the switch body 80 of the switch 42 and the extension/deformation of the resilient element 90 of the switch 42. Once the external force is gone, a resilient restoring force provided by the resilient element 90 of the switch 42 will restore the operating element 32 to its pre-operate state, and thus the abutting relationship between the abutting element 70 and the switch body 80 of the switch 42 will resume. The aforesaid disclosure is exemplified by the situation where the operating element 32 is pressed. The operational relationship between the operating element 31 and the switch 41 and the operational relationship between the operating element 33 and the switch 43 are no different from the operational relationship between the operating element 32 and the switch 42 and thus are not described in detail for the sake of brevity.

The speaker 50, which is no different from a conventional speaker, is disposed on the inner side of the top panel 226 of the case 22 of the base 20 for playing the sound toward the outside of the case 22 through the sound apertures 228.

The circuit module 60 is disposed at the rear panel 24 of the base 20 and connected to a power supplying device (not shown) by means of a power cable 61 (as shown in FIG. 2.) Referring to FIG. 5, the circuit module 60 has a controller 62, a memory 64 electrically connected to the controller 62, a switching element 66 electrically connected to the controller 62, and an audio receiving element 68 electrically connected to the memory 64. The switching element 66 and the audio receiving element 68 are exposed from the outer side of the rear panel 24 (as shown in FIG. 2.) The memory 64 stores a first sound signal, a second sound signal, and a third sound signal. The speaker 50 is electrically connected to the memory 64. The switch bodies 80 of the switches 41, 42, 43 are electrically connected to the controller 62. The switching element 66 can be operated by a person to switch the pet-to-person communicating device 10 between a sound playing mode and a sound recording mode. The audio receiving element 68 is a fixed microphone for receiving a sound and converting the sound into a sound signal. Alternatively, the audio receiving element 68 is a signal transmission element with a slot into which a movable microphone (not shown) is inserted.

When the pet-to-person communicating device 10 is in the sound playing mode, the switches 41, 42, 43 send to the circuit module 60 a start signal (a signal whereby the buttons of the switch bodies 80 of the switches 41, 42, 43 are released from the abutting elements 70, respectively, in this embodiment) corresponding to the sound signals, respectively, as soon as the operating elements 31, 32, 33 are pressed, such that the circuit module 60 sends to the speaker 50 the sound signals corresponding to the start signal received by the circuit module 60, thereby allowing the speaker 50 to generate a sound corresponding to the sound signal. When the pet-to-person communicating device 10 is in the sound recording mode, the circuit module 60 stores the sound signals received by the audio receiving element 68 in the form of the first, second, and third sound signals as soon as the first, second, and third operating elements 31, 32, 33 are pressed, respectively.

A method for use with the pet-to-person communicating device for being operated by pet's instinctive act 10 provided in the aforesaid embodiment comprises the steps of

(a) Providing the pet-to-person communicating device 10.

(b) Storing three sound signals in the memory 64 of the circuit module 60 of the pet-to-person communicating device 10. To be specific, the person sets the pet-to-person communicating device 10 to the sound recording mode first, and then the person presses the first operating element 31 and releases it. After a short time, the device 10 starts to record sounds. Then, the person makes a sound, such as emitting the sound of “I want to eat,” toward a microphone. After the audio receiving element 68 has received the sound signal corresponding to the sound, the memory 64 stores the sound signal in the form of the first sound signal corresponding to the first operating element 31. Alternatively, it is feasible that the person may utter any other message, such as “I want to have fun,” likely to be attributed to a pet while the person is pressing the second and third operating elements 32, 33, such that the message is stored in the form of the second and third sound signals corresponding to the second and third operating elements 32, 33. Eventually, the person operates the switching element 66 to switch the pet-to-person communicating device 10 to the sound playing mode. It should be appreciated that the sounds made by the person to be received by the microphone may be a bell or other sounds and doesn't need to be emitted by the person.

(c) As shown in FIGS. 6-8, applying an operation of one of the operating elements 31, 32, 33 of the pet-to-person communicating device 10 by a pet's pawing motion to make the speaker 50 generate a sound to a person. For example, if the pet presses the first operating element 31 to cause the speaker 50 to generate the sound “I want to eat,” the person will feed the pet. Since applying a press to the operating elements 31, 32, 33 is similar to digging or clawing—an instinctive act commonly performed by pets, such as cats and dogs, the person can easily teach the pet pressing the operating elements 31, 32, 33. The teaching delivered by the person, coupled with feedback timely given by the person, enables the pet to learn using the operating elements 31, 32, 33 to express any messages which the person stores in the pet-to-person communicating device 10. In other words, the pet-to-person communicating device 10, wherein the playback of recorded sound is initiated by a pet's pawing motion, has benefits of allowing pet to interact with the human for bonding, amusement and training. Furthermore, the pet-to-person communicating device 10 is simple in structure. Neither the pet nor the person needs to carry any part of the device 10. Accordingly, the pet-to-person communicating device 10 is convenient to use.

Alternatively, it is feasible that the pet-to-person communicating device for being operated by pet's instinctive act 10 of the present invention dispenses with the sound recording function, whereas preset sound signals are stored in the memory 64 of the circuit module 60. Hence, it is feasible that the circuit module 60 dispenses with the switching element 66 and the audio receiving element 68 such that the method for use with the pet-to-person communicating device 10 entails providing the pet-to-person communicating device 10 by the person and dispensing with the step of storing the sound signals by the person, because the sound signals have been stored in the memory 64 of the circuit module 60 of the pet-to-person communicating device 10 by the time when the person provides the pet-to-person communicating device 10.

Furthermore, the drawings and the above description are illustrative rather than restrictive of the shape of the operating elements 31, 32, 33 and the type of the switches 41, 42, 43. The pet-to-person communicating device 10 of the present invention can function well, provided that the operating elements 31, 32, 33 can be pressed by the pet and can control the switches 41, 42, 43, respectively. However, existing art which can be pressed by the pet, such as push buttons or touch screens, does not fit naturally with the pets' act of digging, pawing or scratching. Therefore, it is more ideal to use the pedal type of operating elements illustrated in the drawings and the above description.

Furthermore, the quantity of the operating elements and the switches of the pet-to-person communicating device 10 and the quantity of the sound signals stored in the memory 64 are not limited to three but have to be equal. In practice, it is feasible that the pet-to-person communicating device 10 can have as few as one operating element and one switch.

The present invention is disclosed above by a preferred embodiment. However, the preferred embodiment is illustrative of the present invention only, but should not be interpreted as restrictive of the scope of the present invention. Hence, all equivalent replacements or changes made to the aforesaid embodiment should fall within the scope of the claims of the present invention.

What is claimed is:

1. A pet-to-person communicating device for being operated by pet's instinctive act, comprising:
a base;
at least an operating element disposed at the base and capable of being operated by aforesaid pet's pawing motion;
a circuit module having a controller and a memory electrically connected to the controller and adapted to store at least a sound signal;
a speaker electrically connected to the circuit module; and
at least a switch electrically connected to the circuit module and controlled by the at least an operating element to send a start signal to the circuit module as soon as the at least an operating element is operated so as to enable the circuit module to send to the speaker the at least a sound signal corresponding to the start signal and thereby allow the speaker to generate a sound corresponding to the at least a sound signal.

2. The pet-to-person communicating device for being operated by pet's instinctive act of claim 1, wherein the at least a switch comprises a switch body electrically connected to the circuit module and an abutting element disposed at the at least an operating element and abutting against the switch body such that, when operated, the at least an operating element tilts and triggers separation of the abutting element and the switch body.

3. The pet-to-person communicating device for being operated by pet's instinctive act of claim 2, wherein the at least a switch further comprises a resilient element having two ends fixed to the at least an operating element and the base, respectively, and providing a resilient restoring force whereby the at least an operating element restores to a pre-operate state.

4. The pet-to-person communicating device for being operated by pet's instinctive act of claim 1, further comprising operating elements and switches controlled by the operating elements, respectively, wherein the memory of the circuit module stores sound signals corresponding to the start signals of the switches, respectively

5. The pet-to-person communicating device for being operated by pet's instinctive act of one of claims 1, wherein the circuit module has a switching element for switching the pet-to-person communicating device between a sound playing mode and a sound recording mode such that, when the pet-to-person communicating device is in the sound playing mode, the speaker generates a sound as soon as one of the operating elements is operated.

6. The pet-to-person communicating device for being operated by pet's instinctive act of claim 5, wherein the circuit module has an audio receiving element electrically connected to the memory such that, when the pet-to-person communicating device is in the sound recording mode, the circuit module stores in the memory the at least a sound signal received by the audio receiving element as soon as one of the operating elements is operated.

7. A method for use with the pet-to-person communicating device for being operated by pet's instinctive act of one of claims 1, comprising the steps of
(a) providing the pet-to-person communicating device;
(b) storing at least a sound signal in a memory of a circuit module of the pet-to-person communicating device; and
(c) applying an operation of the operating element of the pet-to-person communicating device by a pet's pawing motion to make the speaker generate a sound to a person.

8. The method of claim 7, wherein the circuit module of the pet-to-person communicating device for being operated by pet's instinctive act provided in the step (a) has a switching element for switching the pet-to-person communicating device between a sound playing mode and a sound recording mode and an audio receiving element electrically connected to the memory, and the step (b) involves setting the pet-to-person communicating device to the sound recording mode, operating the operating elements of the pet-to-person communicating device by the person, making a gesture by the person to be received by the audio receiving element, storing in the memory the at least a sound signal corresponding to the sound, and operating the switching element by the person to switch the pet-to-person communicating device to the sound playing mode.

9. The method of claim 7, wherein the pet-to-person communicating device for being operated by pet's instinctive act provided in the step (a) comprises first and second operating elements and first and second switches controlled by the first and second operating elements, respectively, and the step (b) involves storing a first sound signal and a second sound signal in the memory of the circuit module of the pet-to-person communicating device, the first sound signal corresponding to a start signal of the first switch, and the second sound signal corresponding to a start signal of the second switch.

10. The method of claim 9, wherein the circuit module of the pet-to-person communicating device for being operated by pet's instinctive act provided in the step (a) has a switching element for switching the pet-to-person communicating device between a sound playing mode and a sound recording mode and an audio receiving element electrically connected to the memory, and the step (b) involves setting the pet-to-person communicating device to the sound recording mode, operating the first operating element by the person, making a sound by the person to be received by the audio receiving element, storing in the memory the at least a sound signal corresponding to the sound in form of the first sound signal, operating the second operating element by the person, making a sound by the person to be received by the audio receiving element, storing in the memory the at least a sound signal corresponding to the sound in form of the second sound signal, and operating the switching element by the person to switch the pet-to-person communicating device to the sound playing mode.
